(19) United States
(12) Patent Application Publication
(10) Pub. No.: US 2011/0057402 A1
(43) Pub. Date: Mar. 10, 2011

(54) MULTI-FUNCTIONAL AND CONVERTIBLE HAND TRUCK

(76) Inventor: Keith Jewell, Santo Domingo Pueblo, NM (US)

(21) Appl. No.: 12/852,842

(22) Filed: Aug. 9, 2010

Related U.S. Application Data
(60) Provisional application No. 61/240,842, filed on Sep. 9, 2009.

(51) Int. Cl. B62B 1/00

(52) U.S. Cl. 280/47.18

(57) ABSTRACT

A multi-functional and convertible hand truck has a combination of release and trigger mechanism to dump the load when operated in wheelbarrow or trailer mode, a damping system and a four wheel brake mechanism. The damping system comprises of a bar that is pulled against the tires of the wheelbarrow through a spring and a mount to hold the assembly. To best fulfill the usability requirement, wheel axle can be positioned slightly forward to the center of gravity. An automatic dumping can be achieved by moving the wheel barrow box relative to the box pivot. The hand truck plate assembly has a pair of brackets welded onto the wheel carriage such that the plate and tires flush when the hand truck is upright. The wheel carriage can be stiffened by using a cross brace.

### CROSS-REFERENCE TO PROVISIONAL APPLICATION

This application claims priority to U.S. Provisional Patent Application Ser. No. 61/240,842, which was filed on Sep. 9, 2009, the disclosure of which is incorporated herein by reference in its entirety.

### TECHNICAL FIELD

Embodiments are generally related to hand trucks used to move a variety of items. Embodiments also relate to the field of hand truck having a series of operating modes. Embodiments additionally relate to multi-functional and convertible hand truck.

### BACKGROUND OF THE INVENTION

Two wheeled hand trucks are commonly used for moving of refrigerators, stoves, boxes and other items. These hand trucks typically have an upright frame with two wheels located near the base of the frame and slightly rearwardly thereof. Handles are provided at an upper portion for tipping of the frame once the load has been secured. A projecting plate is provided at the bottom of the frame for placing of the load thereon. In some cases the load can be merely tipped onto the frame or in other cases straps are used to secure the load to the frame such that it tilts with the truck. The hand trucks come in various sizes and qualities and have a primary use in association with delivery services such as the delivery of boxes.

Some hand trucks are equipped with stair climber wheels, which, as the name implies, are designed to go up and down stairs. Stair climber wheels can sometimes be problematic when trying to turn on flat ground as four wheels in a fixed position will be in contact with the ground.

Hand trucks are fabricated from many different types of materials, tube steel, aluminum tube, aluminum extrusion and high impact plastics. Most commercial hand trucks that are used for beverage and food service deliveries are rugged and very light weight. They are usually designed from two extruded aluminum channel side rails and cast aluminum or magnesium parts.

Attempts have been made to make hand trucks suitable for other purposes and some of these hand trucks have removable handles and an extra set of wheels on the frame. The truck can be converted to a four wheeled wagon type structure for supporting packages or boxes.

In one prior art, a multi-function hand truck is convertible to allow lifting of a load at a spaced distance from the truck and/or is convertible for use as a wheelbarrow is disclosed. A pair of lifting arms co-operate with the frame of the hand truck to extend outwardly there from and allow the frame of the hand truck to provide a mechanical advantage for lifting. The wheels of the truck are moveable rearwardly for conversion to a wheelbarrow mode. An open top container is positioned within the frame of the hand truck for receiving material. The multi-function hand truck is efficiently stored in a vertical orientation.

In another prior art, a multi-purpose hand truck having an elongated frame possessing at one end two wheels as well as toe plate projecting at approximately 90 degree from the frame, and at the other end possessing a handle arrangement is disclosed. In further refinement, the truck can be converted into a utility table by means of a table top and a support stand which are attached to the frame. The table top is on the one hand preferentially pivotally attached to the support stand and on the other hand it pivots and is guided longitudinally in the side members of the frame. For this purpose trunnions projecting transversely from the table top engage in grooves on the inner surfaces of the side members. When the table top is folded out, the toe plate can be pivoted through the frame into a horizontal position so that its underside faces upwards.

In prior art systems, the location of wheels relative to the center of gravity (CG) of the whole wheelbarrow would be a problem. The CG of the whole wheelbarrow is forward of the wheel axel, which causes the wheelbarrow to dump its load unless a user provides a downward force on handles. Additionally, for example with a load of 800 pounds a user provides a downward force on handles with a force of 180 pounds to prevent the entire wheelbarrow from dumping. The distance from the CG of the load to box pivot is also critical. If the CG is over the point then the box will tip automatically with a slight lift of the wheelbarrow. The farther the CG is behind the pivot load, the more force it will be needed to dump the load. The CG is several inches behind the pivot and requires a 260 pound force at the end of the lift bar to dump the box independently of the wheelbarrow. Also, some prior art system does not have a damping system to slow the dump speed.

A gas cylinder is considered to provide to both a dumping force and a damping motion for a wheelbarrow box. Also, a gas cylinder providing over 260 pounds of force is required to dump the box when it is loaded at full capacity. In this type of damping system the user must provide a force to reset the box. Also, wheelbarrow and hand truck handles may fail due to stress on over load.

In an effort to address the foregoing difficulties, it is believed that the implementation of an improved hand truck with combined release and trigger mechanism and automatic damping system may dump the load when operating in wheelbarrow or trailer mode and slow the dump speed.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for a hand truck used to move a variety of items.

It is another aspect of the disclosed embodiments to provide for a hand truck having a series of operating modes.

It is a further aspect of the present invention to provide for a multi functional and convertible hand truck.

The aforementioned aspects and other objectives and advantages can now be achieved as described herein. A set of wheel carriage can be easily disassembled and reassembled with various other components to form a wheelbarrow, wagon, or hand truck and so on. The different components can be quickly rearranged because they are held together by easily removable cotter pins. This versatility enables the user to upgrade or customize the parts in order to create the tool of user needs. The ease of disassembling the units also reduces the need for a large space.

The present invention has a combination of release and trigger mechanism, a damping system and a four wheel brake mechanism. The combination of release and trigger mechanism dumps the load when operated in wheelbarrow or trailer mode. The damping system to slow the dump speed comprises of a bar that is pulled against the tires of the wheelbarrow through a spring and a mount to hold the assembly. A four wheel brake mechanism can be provided with brakes that default to the “on” position when not manually held “off”.

To best fulfill the usability requirement, wheel axle can be positioned slightly forward to the center of gravity. An automatic dumping can be achieved by moving the wheel barrow box relative to the box pivot. The hand truck plate assembly has a pair of brackets welded onto the wheel carriage such that the plate and tires flush when the hand truck is upright. The wheel carriage can be stiffened by using a cross brace. In order to avoid failure of the handlebars during heavy loads, in wheelbarrow and handle truck modes, the thickness of the handlebars can be increased and in wagon mode, the thickness of the main frame can be reduced.

### BRIEF DESCRIPTION OF THE DRAWINGS

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments. Note that in FIGS. 1A-13, identical or similar parts or elements are generally indicated by identical reference numerals.

FIG. 1A illustrates a top view of a carriage and handle assembly, in accordance with the disclosed embodiments;

FIG. 1B illustrates a side view of a carriage and handle assembly, in accordance with the disclosed embodiments;

FIG. 2A illustrates a top view of a wheelbarrow assembly, in accordance with the disclosed embodiments;

FIG. 2B illustrates a side view of a wheelbarrow assembly, in accordance with the disclosed embodiments;

FIG. 3A illustrates a top view of a wagon frame assembly, in accordance with the disclosed embodiments;

FIG. 3B illustrates a side view of a wagon frame assembly, in accordance with the disclosed embodiments;

FIG. 4A illustrates a top view of a hand truck assembly, in accordance with the disclosed embodiments;

FIG. 4B illustrates a side view of a hand truck assembly, in accordance with the disclosed embodiments;

FIG. 5A-5B illustrates a side view of a wheelbarrow assembly depicting force exerted by wheelbarrow on a user at handle, at resting and holding positions respectively, in accordance with the disclosed embodiments;

FIG. 6A-6B illustrates a side view of a wheelbarrow assembly depicting force exerted by a wheelbarrow box on a latch at resting and holding positions respectively, in accordance with the disclosed embodiments;

FIG. 7A illustrates a perspective view of a wheel carriage assembly, in accordance with the disclosed embodiments;

FIG. 7B illustrates a perspective view of a brake assembly utilized in wheel carriage assembly, in accordance with the disclosed embodiments;

FIG. 8 illustrates a perspective view of a hand truck comprising wheel brackets, in accordance with the disclosed embodiments;

FIG. 9 illustrates a perspective view of a hand truck plate flush with wheel, in accordance with the disclosed embodiments;

FIG. 10A-10C illustrates a side view of a custom latch with a hand lever utilized in a wheelbarrow assembly, in accordance with the disclosed embodiments;

FIG. 11 illustrates a perspective view of a wagon main frame, in accordance with the disclosed embodiments;

FIG. 12 illustrates a perspective view of a handlebar, in accordance with the disclosed embodiments; and

FIG. 13 illustrates a perspective view of a wheel carriage comprising a cross-brace, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

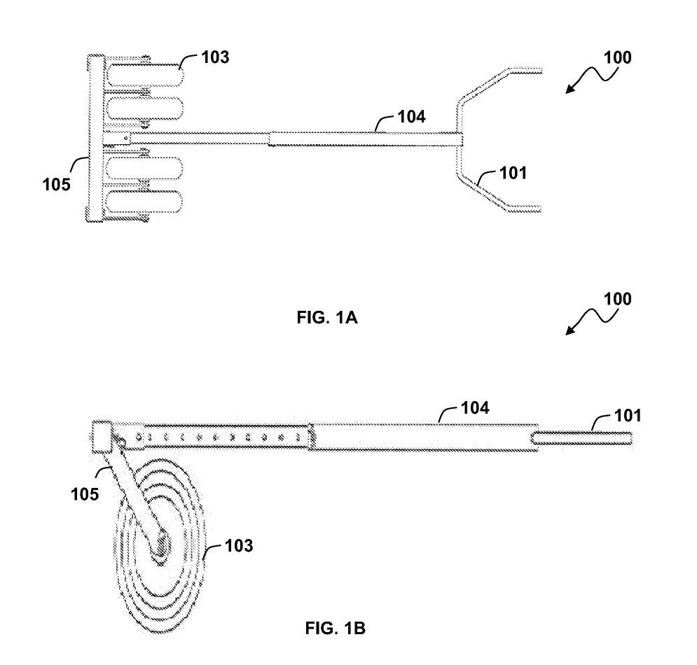

FIG. 1A and FIG. 1B illustrates a top view and a side view of carriage and handle assembly 100 respectively, in accordance with the disclosed embodiments. The carriage and handle assembly 100 comprises of a handle 101, handle bar 104, a wheel carriage 105 and two pairs of wheels 103. The carriage and handle assembly 100 can be easily disassembled and reassembled as they are held together by cotter pins (not shown).

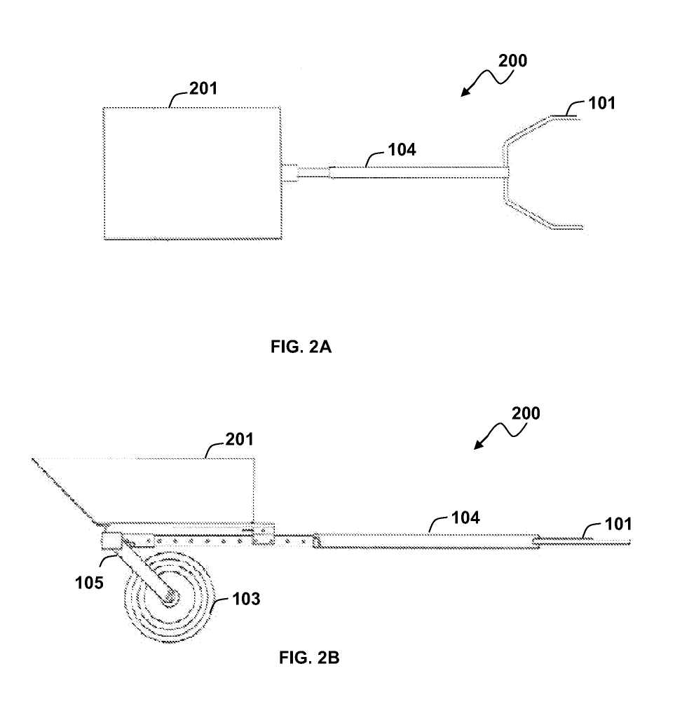

FIG. 2A-4B illustrates the utilization of a carriage and handle assembly 100 depicted in FIG. 1 to form a wheelbarrow 200, a wagon 300, or a hand truck 400. Various carriage attachment assemblies (201, 301 and 401) can be attached with the carriage and handle assembly 100 to form a wheelbarrow assembly 200, a wagon assembly 300, or a hand truck assembly 400.

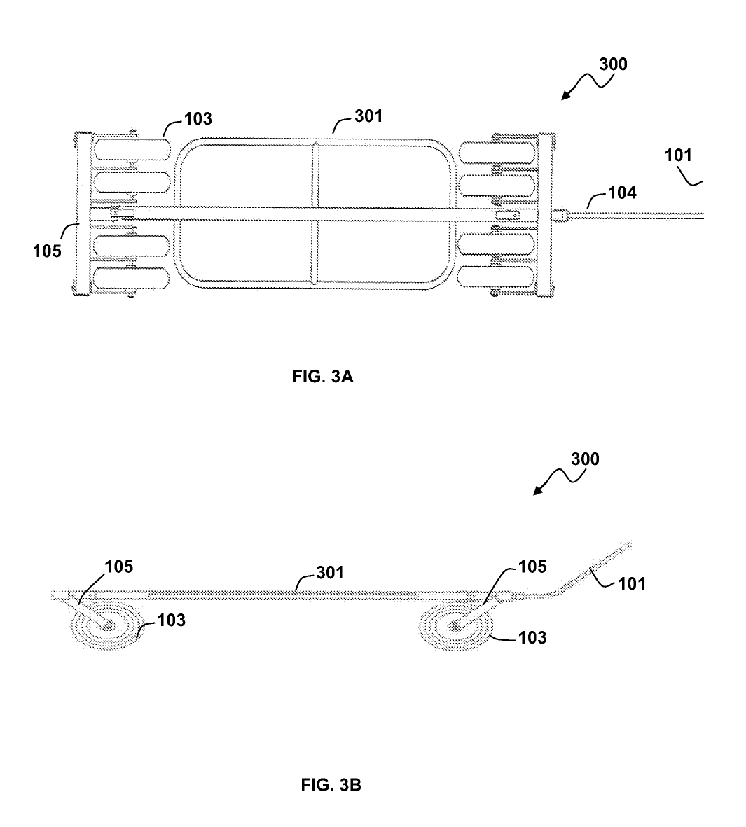

FIG. 2A and FIG. 2B illustrates a top view and a side view of wheelbarrow assembly respectively, in accordance with the disclosed embodiments. The carriage and handle assembly 100 can be easily assembled with wheelbarrow attachment assembly 201 to form a wheelbarrow assembly 200. FIG. 3A and FIG. 3 B illustrates a top view and a side view of wagon frame assembly respectively, in accordance with the disclosed embodiments. The carriage and handle assembly 100 can be easily rearranged and assembled with wagon attachment assembly 301 to form a wheelbarrow 200. Note that, the wagon assembly 300 has an additional set of wheel carriages 105 and wheels 103. The wheelbarrow assembly and wheelbarrow can be referred by same reference numeral 200. Similarly, wagon assembly and wagon are referred by same reference numeral 300 and also hand truck assembly and hand truck can be referred by same reference numeral 400.

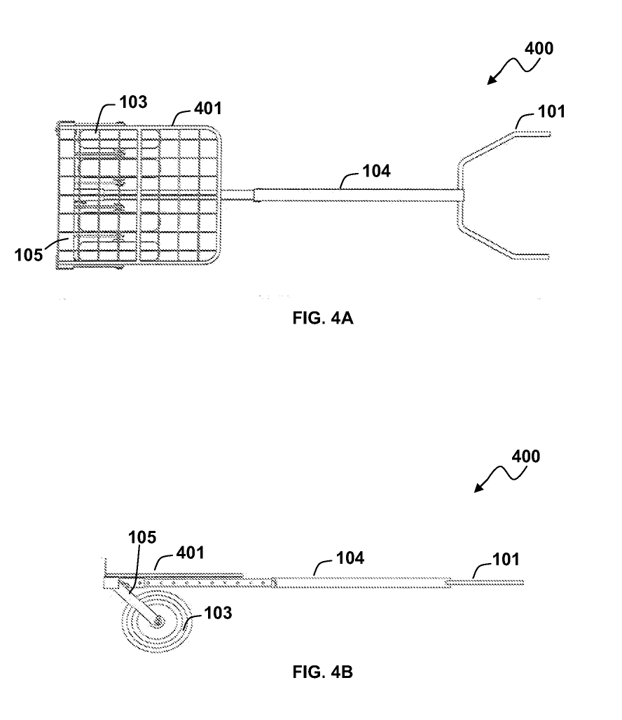

FIGS. 4A and 4B illustrates a top view of hand truck assembly respectively, in accordance with the disclosed embodiments. In this case, the carriage and handle assembly 100 can be rearranged with hand truck attachment assembly 401 to form a hand truck 400.

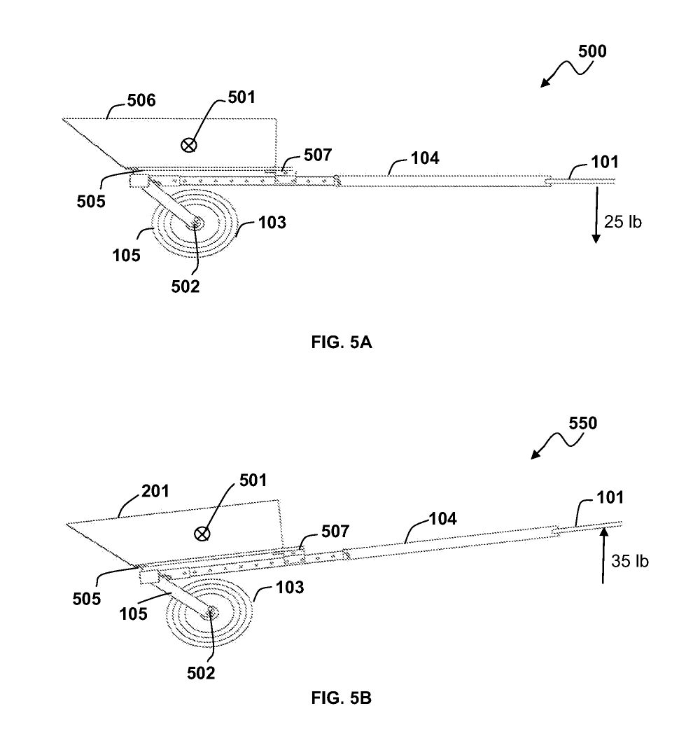

FIG. 5A-5B illustrates a side view of wheelbarrow assembly depicting force exerted by a wheelbarrow on a user at a handle at resting and holding positions respectively, in accordance with the disclosed embodiments. The wheel axel can be positioned slightly forward relative to the center of gravity (CG) 501 of whole wheelbarrow 200. When the wheelbarrow 200 is fully loaded at rest position as depicted in FIG. 5A, the CG 501 is two inches rearward of the wheel axel 502 and directly above the box's pivot 505. When the wheelbarrow 200 is picked up, the CG 501 will sit over the wheel axel 502 causing a 35 pound to be exerted upward at the handle 101.

When the wheelbarrow 200 is loaded fully as depicted at FIG. 5B, the user applies 25 pounds of force to lift the wheelbarrow 200 from rest. At normal holding height of roughly 15 degrees, the user applies 35 pounds of force downward at the handle 101 to keep the wheelbarrow 200 from tipping over.

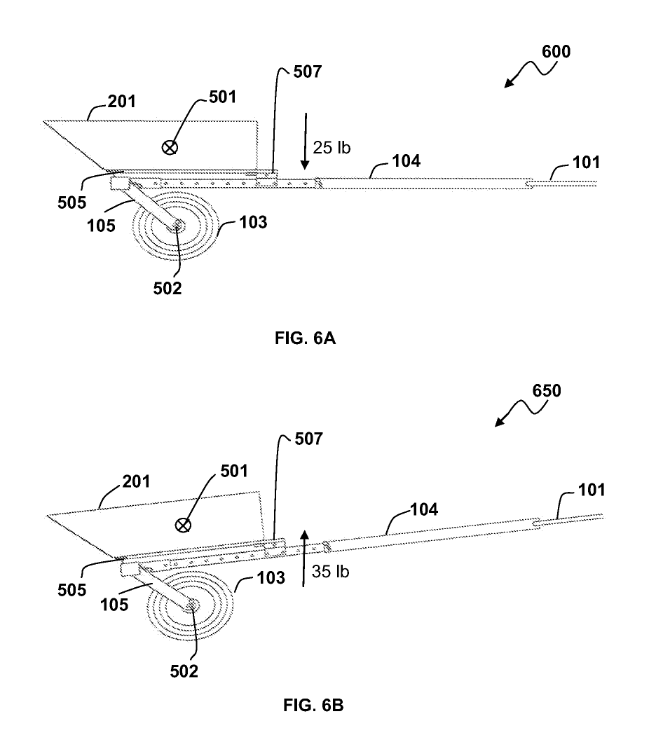

FIG. 6A-6B illustrates a side view of wheelbarrow assembly depicting force exerted by a wheelbarrow box on a latch at resting and holding positions respectively, in accordance with the disclosed embodiments. To achieve automatic dumping, the wheelbarrow box 201 can be moved relative to a box pivot 505. The CG 501 of the box 201 slightly forward of the box pivot 505 is provided. This allows the loaded wheelbarrow box 200 to naturally tip over when it is in the holding position as depicted at FIG. 6B. The loaded wheelbarrow box 201 rotates about its pivot point and dumps upon release of latch system or latch 507.

The automatic dumping is sensitive to both the holding angle and also the highly variable way in which a load can be placed in the wheelbarrow 200. It is designed to function with a flush load of wet sand, equating to an 800 pound load. As the wheelbarrow 200 is lilted forward, the load CG moves forward and the box 201 will dump automatically when the latch is released. If a load is placed toward the rear, the wheelbarrow 200 may be tilted upward quickly (to create momentum) in addition to pulling the latch 507 to dump the load.

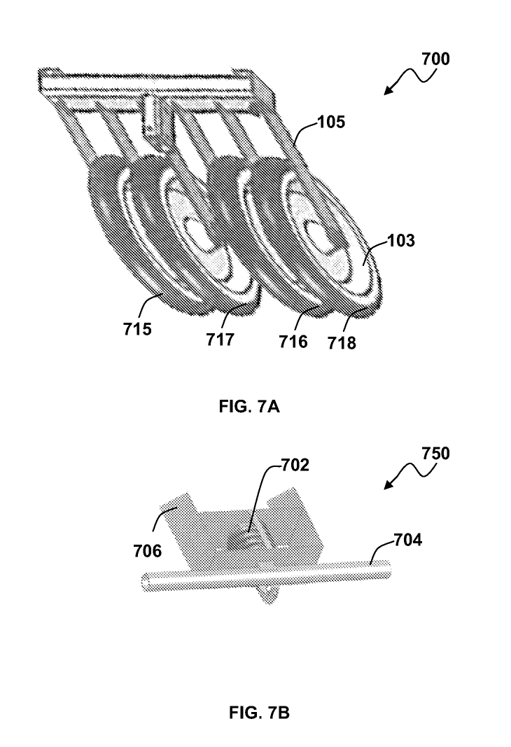

FIG. 7B illustrates a perspective view of a brake assembly utilized in wheel carriage depicted in FIG. 7A, in accordance with the disclosed embodiments. The brake system 501 consists of a bar 704 that is pulled against the tires (715,716,717 and 718) of the wheelbarrow 200 through a spring 702 and a mount 706 to hold the spring 702 and the bar 704. Note that brake system and brakes are generally referred by same reference numeral 750.

To release the brakes 750, the spring 702 is compressed by squeezing a lever (not shown) on the wheelbarrow handle 101. The springs can apply a 100 pound force to the bar 704 braking against the tires (715,716,717 and 718). The handle 101 utilizes a rotary fulcrum (not shown) to reduce the lever squeeze force to 10 pounds.

The brake bar 704 is made from round stock to avoid the wear associated with edges digging into the tire (715,716,717 and 718), and the base of the brake bar 704 is made of square stock to prevent rotation in the mount 706 caused by one tire gripping the brake bar 704 more than another. The bar 704 designed to span the two inside tires (716 and 717) spanning all four tires (715,716,717 and 718) will not increase the overall braking force. However, if control over all four tires (715,716,717 and 718) is desired, the bar (704) can be simply made wider to span all the tires (715,716,717 and 718). The brake (705) can be utilized in wheelbarrow 200, wagon 300 and hand truck 400.

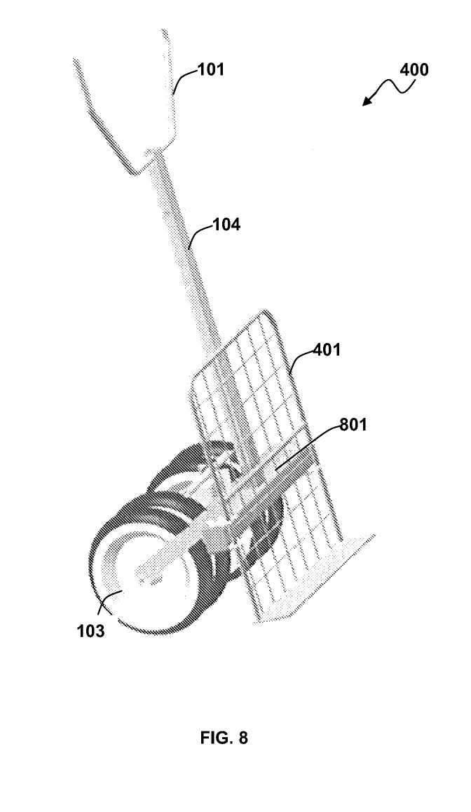

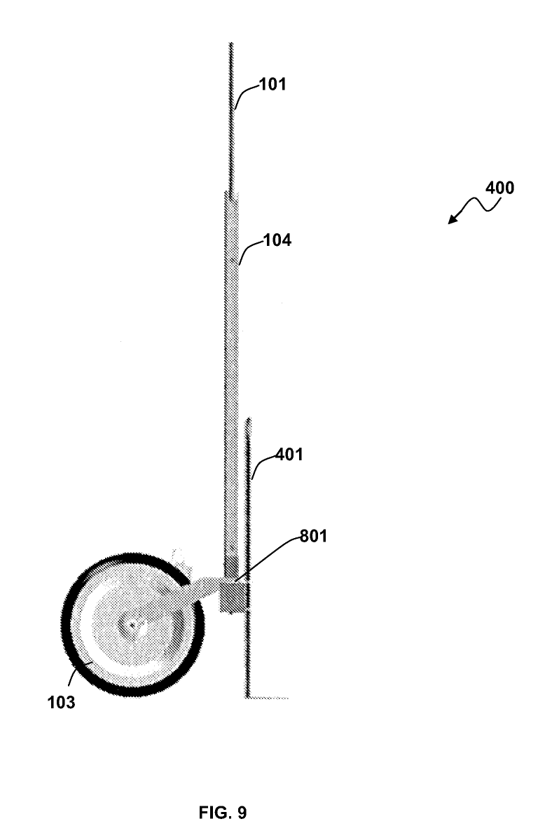

FIG. 8 illustrates a perspective view of hand truck comprising wheel brackets, in accordance with the disclosed embodiments. In case when the brake system 750 depicted in FIG. 7B does not provide enough stopping force, the spring rate can be increased or a knurl can be placed on the round stock (not shown). Two brackets (not shown) can be welded onto the wheel carriage 105 such that the plate 801 and tires (715,716,717 and 718) are flush when the hand truck 400 is upright. Positioning of wheels 715 too far off the ground relative to the plate 801 may cause a heavy load to overcome the operator, especially if the hand truck 400 rocked back too quickly. FIG. 9 illustrates a perspective view of hand truck plate flush with wheel, in accordance with the disclosed embodiments.

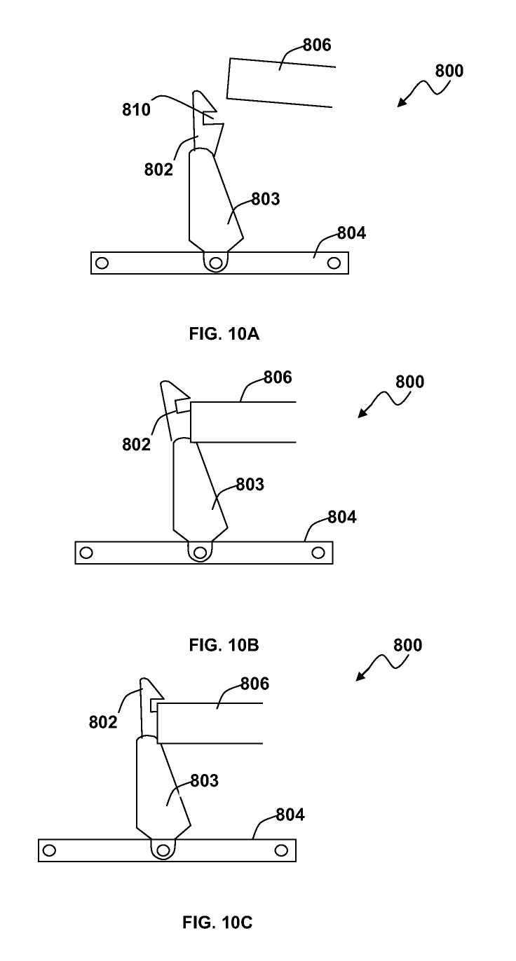

FIG. 10A-10C illustrates a side view of a custom latch with hand lever utilized in wheelbarrow assembly, in accordance with the disclosed embodiments. A latch system 800 consists of a latch 802 and a bracket 803 that mounts to a tongue 804 of the wheelbarrow 200. The bracket 803 also houses two springs (not shown) that helps latch 802 and lock the wheelbarrow box 201 after it returns from dumping.

The latch 802 works by tilting back when down by the wheelbarrow 200 lift bar (not shown). After the C-channel (not shown) reaches the notch 810, it snaps into place. To release, pull on the latch by the means of a lever (not shown) connected to the handle (101). The latch 802 can be manufactured through stamped sheet metal and may be cheaper than a commercial system.

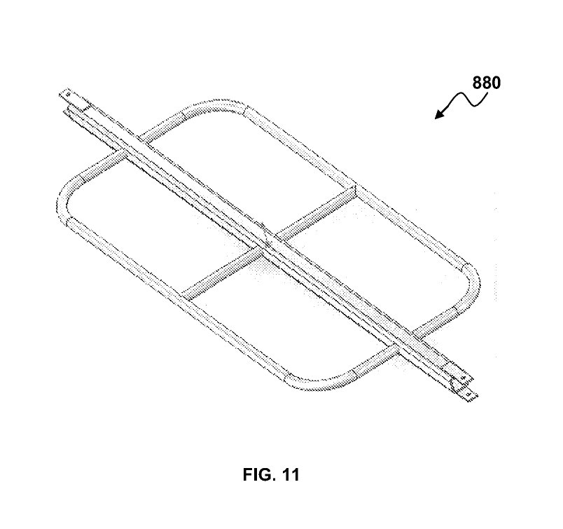

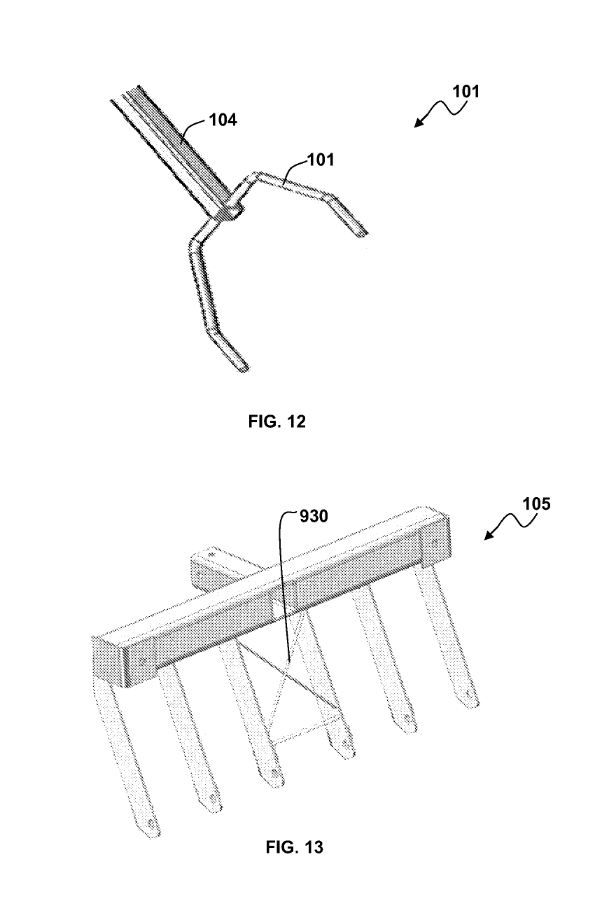

FIG. 11 illustrates a perspective view of wagon main frame, in accordance with the disclosed embodiments. The structural analysis of main frame 880 of wagon 300 shows that the thickness of main beam can be reduced for example 0.125 inches. FIG. 12 illustrates a perspective view of a handlebar, in accordance with the disclosed embodiments. Structural analysis can be performed on wheelbarrow 200 and hand truck 400 handles 101 and tongues 804, among various other components. The handle bars 104 may experience stresses which would cause failure. To avoid this, handle bars 104 can be thickened for example thickness of handle bars 104 can be 0.180 in.

FIG. 13 illustrates a perspective view of wheel carriage comprising a cross-brace, in accordance with the disclosed embodiments. The wheel carriage 105 can be stiffened by using a cross-brace 930.

It will be appreciated that variations of the above disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A multi-functional and convertible hand truck, comprising:
a wheel carriage assembly for supporting a two pair of wheels comprising a wheel carriage and a brake assembly, wherein said brake assembly is secured inside said wheel carriage assembly and said wheel carriage having a cross brace for stiffening said wheel carriage assembly;
a handle assembly for lifting the said hand truck, wherein said handle assembly comprises of a attachment bar and a handle bar;
a plate assembly comprising a pair of wheel brackets for connecting a plate and said wheel carriage; and
a carriage attachment assembly comprising said plate assembly for connecting the said carriage assembly with said wheel carriage assembly.

2. The hand truck of claim 1 can function as a wheelbarrow with automatic dumping by moving said wheelbarrow box relative to a box pivot.

3. The hand truck of claim 1 can function as a wheelbarrow by positioning an axle of said two pair of wheels slightly forward relative to center of gravity of said wheelbarrow on whole.

4. The hand truck of claim 1, wherein said brake assembly comprises of a brake bar and a mount, wherein said bar is pulled against at least one tier of said two pair of wheels.

5. The hand truck of claim 1, wherein said plate and said at least one tires are flushed when said hand truck is upright.

6. The hand truck of claim 1 further comprises of a custom latch with hand lever to reduce force supplied by user.

7. The hand truck of claim 1, wherein said handle bar is thick and comprises of a cap or plate welded at ends.

8. The hand truck of claim 1, wherein said wheel carriage assembly can be quickly rearranged using a plurality of removable cotter pins.

9. The hand truck of claim 1, wherein said carriage attachment assembly can be a hand truck attachment assembly.

10. The hand truck of claim 1, wherein said carriage attachment assembly can be a wheelbarrow attachment assembly.

11. The hand truck of claim 1, wherein said carriage attachment assembly can be a wagon frame attachment assembly.

12. The hand truck of claim 1, wherein said carriage attachment assembly can be a fork truck attachment assembly.

13. The hand truck of claim 1, wherein said carriage attachment assembly can be a trailer attachment assembly.

14. The hand truck of claim 1, wherein said pair of wheel brackets does not provide enough stopping force, spring rate can be increased or a knurl can be placed on said brake bar.
